(19) United States
(12) Patent Application Publication
(10) Pub. No.: US 2015/0360505 A1
(43) Pub. Date: Dec. 17, 2015

(54) PAINTBRUSH HOLDER

(71) Applicant: Ernest Paul Beck, Peculiar, MO (US)

(72) Inventor: Ernest Paul Beck, Peculiar, MO (US)

(21) Appl. No.: 14/302,181

(22) Filed: Jun. 11, 2014

(51) Int. Cl. B44D 3/12; F16M 11/22; F16M 11/02

(52) U.S. Cl. CPC B44D 3/123; F16M 11/02; F16M 11/22

(57) ABSTRACT

A paintbrush holder for holding a plurality of paintbrushes, the paintbrush holder comprises a base including a number of feet, a leg extending upward from the base, a number of arms extending radially outward from a top of the leg, and a handle positioned at the top of the leg. The arms are configured to hold the paintbrushes so that they hang downward for allowing liquid to drip off of the paintbrushes and for allowing the paintbrushes to dry.

### BACKGROUND

Embodiments of the present invention relate to apparatuses for use with paintbrushes.

Paintbrushes often are reused numerous times during a single paint job and often are used for multiple jobs. Between uses, a paintbrush must be stored properly. Improperly storing and transporting a paintbrush can result in damaged paintbrush bristles, paint accumulation on the paintbrush handle, and paint accumulation on other surfaces such as carpet, clothing, and other equipment. Painters currently do not have an easy and compact way to store or transport paintbrushes between uses.

### SUMMARY

A paintbrush holder that allows a user to easily and compactly store and transport paintbrushes is provided. More particularly, a paintbrush holder that allows a user to hang a number of paintbrushes therefrom is provided.

An embodiment of the present invention is a paintbrush holder broadly including a base, a leg, a number of arms, and a handle. The base includes a number of feet for supporting the leg and the arms. The leg extends upward from the feet for holding the arms above the base. The arms extend radially outward from the top of the leg for hanging the paintbrushes therefrom. The handle is positioned at a top of the leg for allowing a user to lift or pick up the paintbrush holder. The paintbrush holder may be positioned in a receptacle such as a bucket or a bag so that paint or water dripping from the paintbrushes is collected in the receptacle, which prevents liquids from getting on nearby surfaces, and to easily store and transport a number of paintbrushes without damaging the paintbrush bristles.

This summary is provided to introduce a selection of concepts in a simplified form that are further described in the detailed description below. The summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a paintbrush holder constructed in accordance with an embodiment of the invention and depicted holding a number of paintbrushes in a receptacle; and

FIG. 2 is an enlarged perspective view of the paintbrush holder of FIG. 1.

The drawing figures do not limit the current invention to the specific embodiments disclosed and described herein. The drawings are not necessarily to scale, emphasis instead being placed upon clearly illustrating the principles of the present invention.

### DETAILED DESCRIPTION OF THE EMBODIMENTS

The following detailed description of the present invention references the accompanying drawings that illustrate specific embodiments in which the present invention can be practiced. The embodiments are intended to describe aspects of the present invention in sufficient detail to enable those skilled in the art to practice the present invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

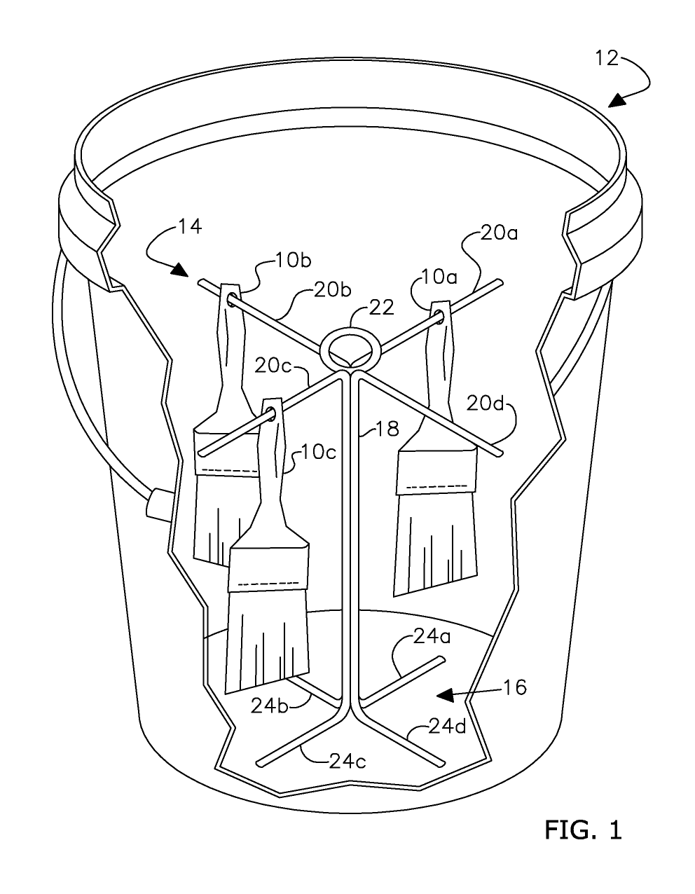

Embodiments of the present invention may be used for holding a number of paintbrushes 10a-c in a receptacle 12, as shown in FIG. 1.

The paintbrushes 10a-c include a handle, a head, and a number of bristles extending from the head. The paintbrushes 10a-c each include a hole, hook, lanyard, or other connecting mechanism on the handle for hanging the paintbrushes 10a-c. The receptacle 12 may be a 5-gallon bucket, painter's bucket, plastic bag, or other receptacle for retaining liquid dripping from one or more paintbrushes and for protecting the paintbrush bristles during storage or transport.

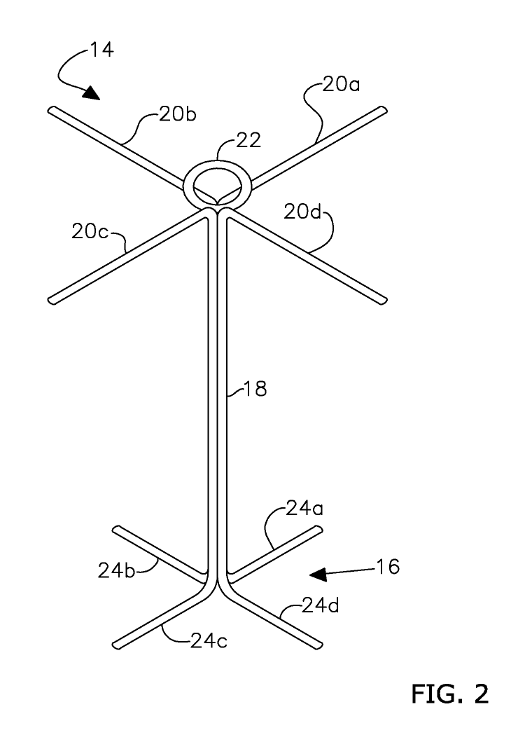

A paintbrush holder 14 constructed in accordance with an embodiment of the invention will now be described in detail, a shown in FIG. 2.

The paintbrush holder 14 is formed of metal rods approximately ⅛^{th} of an inch to ⅜^{ths} of an inch in diameter, molded plastic, wood, or any other suitable material and includes a base 16, one or more legs 18, a number of arms 20a-d, and a handle 22.

The base 16 supports the rest of the paintbrush holder 14 and is sufficiently wide to retain a center of gravity of the paintbrush holder 14 over the base 16 so that the paintbrush holder 14 does not easily tip over. The base 16 may include a number of feet 24a-d. The feet 24a-d extend approximately 4 inches to approximately 12 inches radially from a lower center of the paintbrush holder 14 and substantially equiangularly from each other. The feet 24a-d may extend slightly downward so that only ends of the feet 24a-d contact the bottom of the receptacle 12 or other supporting surface. Alternatively, the base 16 may be formed of one or two wide feet or as few as three narrow feet.

The leg 18 supports the arms 20a-d and the handle 22 above the base 16 and is approximately 6 inches to approximately 24 inches in height. The leg 18 may be formed from the same metal rods that form the feet 24a-d of the base 16 such that the feet 24a-d come together and turn upward to cooperatively form the leg 18. The metal rods may be welded together to strengthen the leg 18.

The arms 20a-d support the paintbrushes 10a-c and extend from a top of the leg 18. The arms 20a-d may be extensions of the metal rods forming the leg 18 so that the feet 24a-d of the base 16, the leg 18, and the arms 20a-d are formed of the same metal rods. The arms 20a-d may be approximately 4 inches to approximately 12 inches in length and may extend equiangularly from each other. The arms 20a-d may extend slightly upward so that the paintbrushes 10a-c are retained on the arms 20a-d. The arms 20a-d may also extend directly above corresponding feet 24a-d of the base 16 so that the each paintbrush 10a-c will be substantially supported by one of the feet 24a-d.

The handle 22 allows a user to lower the paintbrush holder 14 into the receptacle 12, to lift the paintbrush holder 14 out of the receptacle 12, and to carry the paintbrush holder 14. The handle 22 is positioned at a top of the leg 18 near proximal ends of the arms 20a-d and may be a ring, an ergonomically shaped handhold, a hook, or any other component for grasping, mounting, or hanging the paintbrush holder 14.

In use, the paintbrush holder 14 is positioned in the receptacle 12 or on a supporting surface or hung by the handle 22, as shown in FIG. 1. A user may then hang one or more paintbrushes 10a-c on the arms 20a-d by sliding the paintbrushes 10a-c over the ends of the arms 20a-d via the holes of the paintbrushes 10a-c. More than one paintbrush may be hung on any given arm 20a-d and the paintbrush holder 14 will not tip over because the feet 24a-d of the base 16 extend substantially outward to support the paintbrushes 10a-c independently of how the paintbrushes 10a-c are hung. The paintbrushes 10a-c will hang downward without touching the receptacle 12 or the supporting surface so that liquids, e.g., paint or water, can drip off of the bristles of the paintbrushes 10a-c and so that the paintbrushes 10a-c will dry without bending or damaging the bristles. The paintbrush holder 14 will space the paintbrushes 10a-c from each other so that the paintbrushes 10a-c will dry efficiently. The receptacle 12 will prevent liquids on the paintbrushes 10a-c or dripping from the paintbrushes 10a-c from getting on nearby surfaces. The user may then take the paintbrushes 10a-c off of the arms 20a-d and/or the user may lift the paintbrush holder 14 out of the receptacle 12 when the paintbrushes 10a-c are dry.

The paintbrush holder 14 provides numerous advantages over conventional devices and methods for drying, storing, and transporting paintbrushes. For example, the paintbrush holder 14 can be easily placed in a receptacle 12 such as a 5-gallon bucket or a painter's bucket. The feet 24a-d of the base 16 do not become stuck to the bottom of the receptacle 12 because the feet 24a-d extend slightly downward so that only the ends of the feet 24a-d touch the bottom of the receptacle 12. The arms 20a-d prevent the paintbrushes 10a-cfrom sliding off of the paintbrush holder 14 by extending slightly upward. The arms 20a-d also separate paintbrushes from each other so that the paintbrushes dry efficiently and do not become stuck together. Moreover, the arms 20a-d extend substantially over corresponding feet 24a-d of the base 16, which allows numerous paintbrushes to be hung from any one of the arms 20a-dregardless of how many paintbrushes are hung from the other arms. Further, the wet bristles of the hanging paintbrushes 10a-c are not bent or damaged during storage or transport.

Although the present invention has been described with reference to the embodiments illustrated in the attached drawing figures, it is noted that equivalents may be employed and substitutions made herein without departing from the scope of the present invention as recited in the claims. Having thus described various embodiments of the present invention, what is claimed as new and desired to be protected by Letters Patent includes the following:

1. A paintbrush holder for holding a number of paintbrushes, the paintbrush holder comprising:
a base for keeping the paintbrush holder upright;
a leg extending upwards from the base; and
at least one arm for holding one or more of the paintbrushes at a height so that the paintbrush or paintbrushes are elevated above the base.

2. The paintbrush holder of claim 1, wherein the base includes at least 3 feet extending radially from a bottom of the leg and substantially equiangularly from each other.

3. The paintbrush holder of claim 2, wherein the base includes four feet.

4. The paintbrush holder of claim 2, wherein the feet are approximately 4 inches in length.

5. The paintbrush holder of claim 2, wherein the feet extend slightly downward so that the paintbrush holder is supported substantially on the ends of the feet.

6. The paintbrush holder of claim 1, wherein the at least one arm includes 4 arms extending radially from a top of the leg and substantially equiangularly from each other.

7. The paintbrush holder of claim 6, wherein the arms are approximately 5 inches in length.

8. The paintbrush holder of claim 6, wherein the arms extend slightly upward.

9. The paintbrush holder of claim 1, further comprising a handle positioned near a top of the leg for grasping the paintbrush holder.

10. The paintbrush holder of claim 9, wherein the handle is a metal ring.

11. The paintbrush holder of claim 1, wherein the paintbrush holder is formed of molded plastic.

12. The paintbrush holder of claim 1, wherein the paintbrush holder is formed of metal rods.

13. The paintbrush holder of claim 12, wherein the metal rods are approximately 3/16^{ths} of an inch in diameter.

14. A paintbrush holder for holding a number of paintbrushes, the paintbrush holder comprising:
a base including a plurality of feet extending equiangularly from each other for keeping the paintbrush holder upright;
a leg extending upwards from the base;
a plurality of arms extending from a top of the leg, each arm extending substantially parallel to a corresponding foot of the base for holding one or more of the paintbrushes at a height so that the paintbrush or paintbrushes are elevated above the base; and
a handle for grasping the paintbrush holder.

15. The paintbrush holder of claim 14, wherein the feet of the base, the leg, and the arms are formed of four metal rods.

16. The paintbrush holder of claim 15, wherein the four metal rods are welded together.

17. The paintbrush holder of claim 16, wherein the handle is a metal ring welded to a top of the leg.

18. The paintbrush holder of claim 14, wherein the arms extend approximately 13 inches above the bottom of the base.

19. The paintbrush holder of claim 14, wherein the legs are approximately 4 inches long and the arms are approximately 5 inches long.

20. A paintbrush holder for holding a number of paintbrushes, the paintbrush holder comprising:
a base including a plurality of feet extending slightly downward and extending equiangularly from each other for keeping the paintbrush holder upright;
a leg extending upwards from the base;
a plurality of arms extending radially from a top of the leg, each arm extending slightly upward and extending substantially parallel to a corresponding foot of the base for holding one or more of the paintbrushes at a height so that the paintbrush or paintbrushes are elevated above the base; and
a handle for grasping the paintbrush holder,
the paintbrush holder being formed of a plurality of metal rods welded together.
